(19) United States
(12) Patent Application Publication
(10) Pub. No.: US 2006/0166042 A1
(43) Pub. Date: Jul. 27, 2006

(54) Magnetic recording medium having high squareness

(76) Inventor: Daniel M. Seftick, Afton, MN (US)

Correspondence Address: Imation Corp., PO Box 64898, St. Paul, MN, 55164-0898, US

(21) Appl. No.: 11/042,914

(22) Filed: Jan. 24, 2005

(51) Int. Cl. G11B 5/71; G11B 5/706; B05D 5/12; B05D 3/00

(52) U.S. Cl. 428/843.3; 428/844.71; 428/843.4; 428/843.7; 427/130; 427/532

(57) ABSTRACT

A magnetic recording medium comprising a non-magnetic substrate, and an oriented magnetic recording layer having a thickness of from about 0.025 micron to about 0.25 micron coated thereon including at least one non-sintered particulate magnetic metallic pigment having a coercivity of at least about 2000 Oersteds and an average particle length no greater than about 150 nanometers, and a binder system comprising from about 2 to about 10 parts by weight of a polyurethane resin, and from about 1 part to about 10 parts by weight of at least one lubricant selected from the group consisting of fatty acids and fatty acid esters, wherein the magnetic recording medium has a squareness of at least about 0.95 when measured at a field strength of 6000 Oe.

### THE FIELD OF THE INVENTION

The present invention relates generally to magnetic recording tapes useful in belt driven tape cartridges, more specifically to single layer magnetic recording media having high squareness values.

### BACKGROUND OF THE INVENTION

Magnetic recording media are widely used in audio tapes, video tapes, computer tapes, disks and the like. Magnetic media may use thin metal layers as the recording layers, or may comprise coatings containing magnetic particles as the recording layer. The latter type of recording media employs particulate materials such as ferromagnetic iron oxides, chromium oxides, ferromagnetic alloy powders and the like dispersed in binders and coated on a substrate. In general terms, such magnetic recording media generally comprise a magnetic layer coated onto at least one side of a non-magnetic substrate (e.g., a film for magnetic recording tape applications). The formulation for the magnetic coating is optimized to maximize the performance of the magnetic recording medium.

Magnetic recording media also typically have a backside coating applied to the opposing side of the non-magnetic substrate in order to improve the durability, conductivity, and tracking characteristics of the media.

Particulate based magnetic recording media include a granular pigment. Popular pigments are metal oxides, ferromagnetic metal oxides, and ferromagnetic metal alloys. Different pigments have different surface properties; the metal particles often have a strongly basic surface. Recording media often utilize alpha hematite (α-Fe₂O₃) particles in the formulations such as gamma iron oxide (γ-Fe₂O₃), magnetite (Fe₃O₄), cobalt-doped iron oxides, or ferromagnetic metal or metal alloy powders, along with carbon black particles.

Front coatings or magnetic recording layers generally include a binder composition. The binder composition performs such functions as dispersing the particulate materials, increasing adhesion between layers and to the substrate, improving gloss and the like. As might be expected, the formulation specifics as well as coating of the binder compositions to an appropriate substrate are highly complex, and vary from manufacturer to manufacturer; however, most binders include such materials as thermoplastic resins.

It would be desirable to provide a single layer magnetic recording medium which would have a high degree of squareness and a high recording density while providing such benefits as thinness and attendant increased capacity.

It has now been discovered that a magnetic recording medium may be made which has a squareness of at least about 0.95 when measured at 6000 Oersteds (Oe). Such media balance use of certain particles, and process parameters and are oriented in a high magnetic field.

### SUMMARY OF THE INVENTION

The invention provides a magnetic recording medium including a non-magnetic substrate, having an oriented single magnetic coating on the front side of the substrate. The magnetic layer contains at least one metallic particulate pigment, and a binder system therefor.

Specifically, a magnetic recording medium of the invention comprises a magnetic recording medium comprising a non-magnetic substrate, and an oriented magnetic recording layer having a thickness of from about 0.025 micron to about 0.25 micron coated on the substrate, where the magnetic recording layer includes at least one non-sintered particulate magnetic metallic pigment having a coercivity of at least about 2000 Oersteds and an average particle length of no greater than about 150 nanometers, and a binder system comprising from about 2 to about 10 parts by weight of a polyurethane resin, and from about 1 part to about 10 parts by weight of at least one lubricant selected from the group consisting of fatty acids and fatty acid esters, wherein the magnetic recording medium has a squareness of at least about 0.95 when measured at a field strength of 6000 Oe.

The magnetic recording medium of the invention is oriented in a magnetic field, preferably during the time when the magnetic recording layer is drying on the substrate.

In another embodiment, the invention provides a magnetic recording tape having longitudinal tracks comprising a non-magnetic substrate, and a magnetic recording layer coated on the substrate comprising at least one non-sintered particulate magnetic metallic pigment having a coercivity of at least about 2000 Oersteds and an average particle length no greater than about 150 nanometers, and a binder system comprising from about 2 to about 10 parts by weight of a polyurethane resin, and from about 1 part to about 10 parts by weight of at least one lubricant selected from the group consisting of fatty acids and fatty acid esters, wherein the magnetic recording layer is concurrently dried while being oriented in a magnetic field; the magnetic recording medium has a squareness of at least about 0.95 when measured at a field strength of 6000 Oe.

The invention further provides an oriented magnetic recording medium wherein the magnetic recording medium has a squareness of at least about 0.90 when measured at a field strength of 10,000 Oe.

The invention further provides a method for making a magnetic recording medium wherein said magnetic recording layer is coated from a dispersion having a solids content of at least about 30%.

The invention also provides a method for making a magnetic recording medium according to claim 1 wherein said magnetic recording layer is oriented by means of exposure to a magnetic field having a strength of at least about 6000 Gauss.

1. The term “coating composition” means a composition suitable for coating onto a substrate.

2. The terms “layer” and “coating” are used interchangeably to refer to a coated composition.

3. The terms “back coating” and “backside coating” are synonymous and refer to a coating on the opposing side of the substrate from a magnetic layer.

4. The term “vinyl” when applied to a polymeric material means that the material comprises repeating units derived from vinyl monomers. When applied to a monomeric material, the term “vinyl” means that the monomer contains a moiety having a free-radically polymerizable carbon-carbon double bond.

6. The term “coercivity” means the intensity of the magnetic field needed to reduce the magnetization of a ferromagnetic material to zero after it has reached saturation, taken at a saturation field strength of 10,000 Oersteds.

7. The term “Oersted,” abbreviated as Oe, refers to a unit of magnetic field in a dielectric material equal to 1/μ Gauss, where μ is the magnetic permeability.

8. The term “squareness” refers to a measure of magnetic orientation equal to the ratio of the remanent to the saturated flux (or moment) as tested on a Vibrating Sample Magnetometer.

9. The term “linear tape open” means a linear tape; the open refers to format and means that a variety of formats produced by different vendors may be available.

10. The term “linear tracks” refers to the individual tracks organized in a linear fashion for deposition of data. Data tracks are organized into data bands and regions.

All weights, amounts and ratios herein are by weight, unless otherwise specifically noted.

### DETAILED DESCRIPTION OF THE PREFERRED EMBODIMENTS

The following detailed description describes certain embodiments and is not to be taken in a limiting sense. The scope of the present invention is defined by the appended claims.

The magnetic recording medium includes a non-magnetic substrate and a single magnetic layer. The various components are described in greater detail below. In general terms, however, the single magnetic layer includes a primary magnetic metal pigment, and a binder for the pigment.

The Magnetic Recording Medium

The magnetic recording medium of the invention may be any medium known in the art for recording of information, audio or video signals.

In one embodiment, the magnetic recording medium of the invention is a linear magnetic recording tape; that is, a magnetic recording tape having longitudinal tracks, including Linear Tape Open specifications according to ECMA International Standards.

The Magnetic Recording Layer

In accordance with the current invention, the magnetic recording layer is a thin layer, being preferably from about 1 micro-inch (0.025μ) to about 10 micro-inches (0.25μ) in thickness, preferably from about 1 micro-inch to about 8 micro-inches including at least one type of magnetic particulate material.

The magnetic recording medium of the invention has a squareness of at least about 0.95 when measured at a field strength of 6000 Oe. In one embodiment, the magnetic recording medium has a squareness of at least about 0.90 when measured at a field strength of 10,000 Oe. The magnetic recording medium of the invention is formed using non-sintered magnetic pigments having a coercivity of at least about 2000 Oe, and formed from a high solids dispersion which undergoes its first processing steps at a solids concentration of at least about 75% solids, and is subsequently coated at a dispersion concentration of at least about 30% solids. After the dispersion is coated onto a substrate, it is oriented in a magnetic field and then dried, or is oriented in the magnetic field and dried concurrently.

The magnetic metal particle pigments have a composition including but not limited to, metallic iron and/or alloys of iron with cobalt and/or nickel, and magnetic or non-magnetic oxides of iron, other elements, or mixtures thereof. Alternatively, the magnetic particles can be composed of hexagonal ferrites such as barium ferrites. In order to improve the required characteristics, the preferred magnetic powder may contain various additives, such as semi-metal or non-metal elements and their salts or oxides such as Al, Nd, Si, Co, Y, Ca, Mg, Mn, Na, etc. The selected magnetic powder may be treated with various auxiliary agents before it is dispersed in the binder system, resulting in the primary magnetic metal particle pigment. Preferred pigments have an average particle length of about 150 nanometers (nm) or less. Such pigments are available from companies such as Toda Kogyo, Kanto Denka Kogyo, and Dowa Mining Company. As noted above, pigments useful in magnetic recording media of the invention have a minimum coercivity of at least about 2000 Oe. Useful particles are separate and non-sintered to expose all surfaces of the particles to adequate wetting during the dispersion processing. Particles must be produced as individual entities (non-sintered) and then maintain this individuality during subsequent processing (drying, reduction, packaging). Some amount of aggregation is required for handling, but the aggregates must exist in a form that is easily broken down for magnetic recording medium production.

In addition to the preferred magnetic metal particle pigments described above, the magnetic layer further includes soft spherical particles. Most commonly these particles are comprised of carbon black. A small amount, preferably less than about 3%, of at least one relatively large particle carbon material may also be included, preferably a material that includes spherical carbon particles. The large particle carbon materials have a particle size on the order of from about 50 to about 500 nm, more preferably from about 70 to about 300 nm. Spherical large carbon particle materials are known and commercially available, and in commercial form can include various additives such as sulfur to improve performance. The remainder of the carbon particles present in the layer are small carbon particles, i.e., the particles have a particle size on the order of less than 100 nm, preferably less than about 50 nm.

The magnetic layer also includes an abrasive or head cleaning agent (HCA) component. One preferred HCA component is aluminum oxide. Other abrasive grains such as silica, ZrO₂, Cr₂O₃, etc., can also be employed, either alone or in mixtures with aluminum oxide or each other.

The binder system associated with the magnetic layer preferably incorporates at least one binder resin, such as a thermoplastic resin, in conjunction with other resin components such as binders and surfactants used to disperse the HCA, a surfactant (or wetting agent), and one or more hardeners. In one embodiment, the binder system of the magnetic layer includes multiple resin components in combination with the other binder components. One type of resin component, sometimes called a hard resin, typically has a glass transition temperature (Tg) of at least about 70° C., and another type of useful resin component typically has a glass transition temperature of less than about 68° C.

The binder system also contains other resin components such as binders and surfactants used to disperse the HCA, a surfactant (or wetting agent), and one or more hardeners. In one embodiment, the binder system of the magnetic recording layer includes a combination of a primary polyurethane resin and a vinyl chloride resin. Examples of polyurethanes include polyester-polyurethane, polyester-polyurethane, polycarbonate-polyurethane, polyester-polycarbonate-polyurethane, and polycaprolactone-polyurethane. Other acceptable vinyl chloride resins such as vinyl chloride-vinyl acetate copolymer, vinyl chloride-vinyl acetate-vinyl alcohol copolymer, and vinyl chloride-vinyl acetate-maleic anhydride can also be employed with the primary polyurethane binder. Resins such as bis-phenyl-A-epoxy, styrene-acrylonitrile, and nitrocellulose may also be acceptable.

In another embodiment, the magnetic layer comprises a binder system including both a polyurethane resin and a non-halogenated vinyl resin. Examples of polyurethanes include polyether-polyurethane, polyester-polyurethane, polycarbonate-polyurethane, polyester-polycarbonate-polyurethane, and polycaprolactone-polyurethane. Non-halogenated vinyl resins comprised of styrene and acrylonitrile monomers can also be employed with the primary polyurethane binder, if desired. In this embodiment, the primary polyurethane binder is typically incorporated into the magnetic layer in an amount of from about 2 to about 10 parts by weight, and preferably from about 4 to about 8 parts by weight, based on 100 parts by weight of the primary magnetic layer pigment, and the non-halogenated vinyl binder is incorporated in an amount of from about 2 to about 15 parts by weight, and preferably from about 3 to about 10 parts by weight, based on 100 parts by weight of the primary magnetic layer pigment.

The binder system further typically includes an HCA binder used to disperse the selected HCA material, such as a polyurethane paste binder (in conjunction with a pre-dispersed or paste HCA). Alternatively, other HCA binders compatible with the selected HCA format (e.g., powder HCA) are acceptable. As with other ingredients, HCA may be added to the main dispersion separately or dispersed in the binder system, and then added to the main dispersion.

The magnetic layer may further contain one or more lubricants such as a fatty acid and/or a fatty acid ester. The incorporated lubricant(s) exist throughout the front coating and, importantly, at the surface of the magnetic layer. The lubricant(s) reduces friction to maintain smooth contact with low drag, and protects the media surface from wear.

Some fatty acid lubricants include at least 90 percent pure stearic acid. Although technical grade acids and/or acid esters can also be employed for the lubricant component, incorporation of high purity lubricant materials ensures robust performance of the resultant medium. Other acceptable fatty acids include one or more of myristic acid, palmitic acid, oleic acid, etc., and their mixtures. The magnetic layer formulation can further include one or more fatty acid esters such as butyl stearate, isopropyl stearate, butyl oleate, butyl palmitate, butyl myristate, hexadecyl stearate, and oleyl oleate.

In one embodiment, the lubricant is incorporated into the magnetic layer in an amount of from about 1 to about 10 parts by weight, and preferably from about 1 to about 5 parts by weight, based on 100 parts by weight of the primary pigment.

The binder system may also contain a conventional surfactant or wetting agent. Known surfactants, e.g., adducts of sulfuric, sulfonic, phosphoric, phosphonic, and carboxylic acids, are acceptable.

The coating composition may also contain a hardening agent such as isocyanate or polyisocyanate. In a preferred embodiment, the hardener component is incorporated into the magnetic layer in an amount of from about 1 to about 6 parts by weight, and preferably from about 2 to about 3 parts by weight, based on 100 parts by weight of the primary magnetic pigment.

The materials for the magnetic layer are mixed with the primary pigment and coated atop the substrate. Useful solvents associated with the magnetic layer coating material include methyl ethyl ketone (MEK) preferably having a concentration of from about 40% to about 90%, methyl isobutyl ketone (MIBK) having a concentration of from about 10% to about 30%, tetrahydrofuran (THF) having a concentration of up to about 10%, and toluene (Tol), of concentrations from about 0% to about 40%. Alternatively, other ratios can be employed, or even other solvents or solvent combinations including, for example, xylene, cyclohexanone, and methyl amyl ketone, are acceptable.

Substrate

The substrate can be any conventional non-magnetic film substrate useful as a magnetic recording tape support. Exemplary substrate materials useful for magnetic recording tapes include polyesters such as polyethylene terephthalate (PET), polyethylene naphthalate (PEN), a mixture of polyethylene terephthalate and polyethylene naphthalate; polyolefins (e.g., polypropylene); cellulose derivatives; polyamides; and polyimides. Thickness of the film may vary from about 175 microinches to about 950 microinches in thickness.

Back Coat

The back coat, if used, is generally of a type conventionally employed, and thus primarily consists of a soft (i.e., Moh's hardness <5) non-magnetic particle material such as carbon black or silicone dioxide particles. In one embodiment, the back coat layer comprises a combination of two kinds of carbon blacks, including a primary, small carbon black component and a secondary, large texture carbon black component, in combination with appropriate binder resins. The primary, small carbon black component preferably has an average particle size on the order of from about 10 to about 25 nm, whereas the secondary, large carbon component preferably has an average particle size on the order of from about 50 to about 300 nm.

As is known in the art, back coat pigments dispersed as inks with appropriate binders, surfactant, ancillary particles, and solvents are typically purchased from a designated supplier. In a preferred embodiment, the back coat binder includes at least one of: a polyurethane resin, a phenoxy resin, or nitrocellulose added in an amount appropriate to modify coating stiffness as desired.

Process for Manufacture

The coating materials of the front layer according to the present invention are prepared by dispersing the corresponding powders or pigments and the binders in a solvent. The metal particle powdered pigment materials are placed in a high solids mixing device along with certain of the resins (i.e., polyurethane binder, vinyl binder, and surfactant) and the solvent and processed for a period of from less than about 1 hour to about 4 hours, preferably in about 75% solids. The resulting material is processed in a high-speed impeller dissolver for about 30 to about 90 minutes, along with additional amounts of the solvent. Following this letdown processing, the resulting composition is subjected to a sandmilling or polishing operation. Subsequently, the HCA and related binder components are added, and the composition left standing for about 30 to about 90 minutes. Following this letdown procedure, the composition is processed through a filtration operation, and then stored in a mixing tank at which the hardener component and lubricants are added. The resulting material is then ready for coating onto the substrate. The final dispersion to be coated has a solids content of at least about 30%.

The magnetic recording layer is coated onto the substrate using conventional methods and is then oriented by exposure to a high magnetic field, having a strength of at least about 6000 Oe. The coating is preferably oriented during the drying process.

The process for manufacture of the magnetic recording medium may include an in-line portion and one or more off-line portions. The in-line portion, includes unwinding a non-magnetic substrate or other material from a spool or supply. The substrate is coated with the back-coating on one side of the substrate. Next, the backside coating is dried, typically using conventional ovens. The magnetic recording layer is applied to the substrate. Alternatively, the front coating can occur prior to the backcoating. The coated substrate is magnetically oriented and dried, and then proceeds to the in-line calendering station. According to one embodiment, called compliant-on-steel (COS), in-line calendering uses one or more in-line nip stations, in each of which a steel or other generally non-compliant roll contacts or otherwise is applied to the magnetically coated side of the substrate, and a rubberized or other generally compliant roll contacts or otherwise is applied to the backcoated side. The generally non-compliant roll provides a desired degree of smoothness to the magnetically coated side of the substrate. Alternately, the in-line calendering is “steel-on-steel,” (SOS), meaning both opposing rolls are steel. The process may also employ one or more nip stations each having generally non-compliant rolls. After in-line calendering, the substrate or other material is wound. The process then proceeds to an off-line portion which occurs at a dedicated stand-alone machine. The coated substrate is unwound and then is calendered. The off-line calendering includes passing the coated substrate through a series of generally non-compliant rollers, e.g. multiple steel rollers, although materials other than steel may be used. The coated, calendered substrate then is wound a second time. The wound roll is then slit, burnished, and tested for defects according to methods known in the industry.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

### EXAMPLES

### Examples 1-5 and Comparative Example C6

Sample 1 was prepared from a dispersion at 30% solids formulated using a magnetic particle, Dowa HT103A2 MP, using a polyvinyl chloride binder formulation and processed in a high solids mixing device with the solvent for about 1 hour. A 0.95 squareness value was measured. Samples 2 and 3 were made with similar formulations using Dowa HM156 and HM131 particles, respectively. Sample 4 was made with Dowa HM149 to demonstrate that an appropriate MP must be selected to produce such high squareness values. HM131 was also formulated in Sample 5 but the levels of surface modifier and polymers were different compared to Sample 3. In Sample 6, HT103A2 was formulated in the same way as Sample 1 but was orientated at a lower strength field and not allowed to dry in the field.

In Table 2, a plus sign indicates that the conditions for high squareness have been met. For the particle, it indicates that the particle is non-sintered and non-agglomerated or only slight agglomerated. For the process, it indicates the dispersion was first processed with a high solids content and was coated at about 30% solids. A dashed line means that the conditions were not met.

TABLE 1
Particle data is as follows:

| | LENGTH | POWDER COERCIVITY |
|---|---|---|
| SAMPLE | (nanometers) | (Oersteds) |
| 1. particle HT103A2 | 75 | 2465 |
| 2. particle HM156 | 75 | 2625 |
| 3 and C5- particle HM131 | 75 | 2360 |
| 4. particle HM149 | 75 | 2015 |

TABLE 2

| SAMPLE | # | PARTICLE | PROCESS | SQUARENESS |
|---|---|---|---|---|
| 1 | 1063-67-4-6 | + | + | 0.95 |
| 2 | 1098-45-4-6 | + | + | 0.96 |
| 3 | 899-33-4 | + | + | 0.95 |
| 4 | 1063-76-2-6 | −− | + | 0.91 |
| 5 | 899-33-3 | + | + | 0.92 |
| C6 | 1063-67-4-1.6 | + | −− | 0.71 |

What is claimed is:

1. A magnetic recording medium comprising a non-magnetic substrate, and an oriented magnetic recording layer having a thickness of from about 0.025 micron to about 0.25 micron coated on said substrate, said magnetic recording layer comprising at least one non-sintered particulate magnetic metallic pigment having a coercivity of at least about 2000 Oersteds and an average particle length no greater than about 150 nanometers, and a binder system comprising from about 2 to about 10 parts by weight of a polyurethane resin, and from about 1 part to about 10 parts by weight of at least one lubricant selected from the group consisting of fatty acids and fatty acid esters, said magnetic recording medium having a squareness of at least about 0.95 when measured at a field strength of 6000 Oe.

2. The medium of claim 1 wherein the magnetic recording medium has a squareness of at least about 0.90 when measured at a field strength of 10,000 Oe.

3. The medium of claim 1 wherein said magnetic recording layer comprises a mixture of non-sintered particulate magnetic metallic pigments.

4. The medium of claim 1 wherein said magnetic recording layer further comprises a combination of particulate carbon materials; one particulate carbon material having a particle size on the order of from about 50 to about 500 nm, and a second particulate carbon material having a particles size of less than about 50 nm.

5. The medium of claim 1 wherein said binder system for said magnetic recording layer binder system comprises a combination of resin binders.

6. The medium of claim 5 wherein said binder system further comprises from about 2 to about 20 parts by weight of a vinyl chloride resin.

7. The medium of claim 5 wherein said binder system further comprises from about 2 to about 15 parts by weight of a non-halogenated vinyl resin.

8. The medium of claim 1 wherein the magnetic recording layer comprises at least one non-sintered particulate magnetic metallic pigment, from about 2 to about 10 parts by weight of a polyurethane resin, from about 2 to about 15 parts by weight of a vinyl chloride resin, from about 1 to about 6 parts by weight of a hardener, and from about 1 to about 10 parts a lubricant mixture comprising a fatty acid ester lubricant, and a fatty acid lubricant.

9. A method for making the magnetic recording medium of claim 1 wherein said magnetic recording layer is oriented by means of exposure to a magnetic field having a strength of at least about 6000 gauss.

10. A method for making the medium of claim 1 wherein said magnetic recording layer is exposed to said magnetic field and concurrently dried.

11. A method for making the medium of claim 1 wherein said magnetic recording layer is coated from a dispersion having a solids content of at least about 30%.

12. A method for making the medium of claim 11 wherein said dispersion for said magnetic recording layer is initially processed at a solids content greater than about 75%.

13. A method for making the medium of claim 11 wherein the medium is oriented in a magnetic field concurrently with drying of said magnetic recording layer.

14. A magnetic recording medium comprising a non-magnetic substrate, and a magnetic recording layer coated on said substrate, said magnetic recording layer comprising at least one non-sintered particulate magnetic metallic pigment having a coercivity of at least about 2000 Oersteds and an average particle length no greater than about 150 nanometers, and a binder system comprising from about 2 to about 10 parts by weight of a polyurethane resin, and from about 1 part to about 10 parts by weight of at least one lubricant selected from the group consisting of fatty acids and fatty acid esters, wherein the magnetic recording layer is concurrently dried while being oriented in a magnetic field, said magnetic recording medium having a squareness of at least about 0.95 when measured at a field strength of 6000 Oe.

15. The medium of claim 14 wherein said magnetic recording layer is oriented in a magnetic field having a strength of about 6000 Oe.

16. The medium of claim 14 wherein the magnetic recording medium has a squareness of at least about 0.90 when measured at a field strength of 10,000 Oe.

17. A magnetic recording medium having longitudinal tracks comprising a non-magnetic substrate, and a magnetic recording layer coated on said substrate, said magnetic recording layer comprising at least one non-sintered particulate magnetic metallic pigment having a coercivity of at least about 2000 Oersteds and an average particle length no greater than about 150 nanometers, and a binder system comprising from about 2 to about 10 parts by weight of a polyurethane resin, and from about 1 part to about 10 parts by weight of at least one lubricant selected from the group consisting of fatty acids and fatty acid esters, wherein the magnetic recording layer is concurrently dried while being oriented in a magnetic field, said magnetic recording medium having a squareness of at least about 0.95 when measured at a field strength of 6000 Oe.
